(19) United States
(12) Patent Application Publication
(10) Pub. No.: US 2016/0351055 A1
(43) Pub. Date: Dec. 1, 2016

(54) ACCIDENT PREVENTION DEVICE

(71) Applicant: Bill Seid, Branchburg, NJ (US)

(72) Inventor: Bill Seid, Branchburg, NJ (US)

(21) Appl. No.: 15/140,453

(22) Filed: Apr. 27, 2016

Related U.S. Application Data
(60) Provisional application No. 62/154,943, filed on Apr. 30, 2015.

(51) Int. Cl. G08G 1/16; G08G 1/0962; B60Q 9/00

(52) U.S. Cl. CPC G08G 1/166; B60Q 9/008; G08G 1/0962; B60Q 2400/40; B60Q 2300/43

(57) ABSTRACT

An illuminated electronic sign that is easily installable in the rear window or on a rear bumper of a vehicle capable of displaying a visible request to a following driver to cease unsafe tailgating.

### CLAIM OF PRIORITY

This patent application claims priority under 35 USC 119 (e) (1) from U.S. Provisional Patent Application Ser. No. 62/154,943 filed Apr. 30, 2015, of common inventorship herewith entitled, “Front and rear Accident Prevention Device,” which is incorporated herein by reference as though the same were set forth in its entirety.

### FIELD OF THE INVENTION

The present invention pertains to the field of automobile accessories, and more specifically to the field of illuminated safety signs.

### BACKGROUND OF THE INVENTION

The prior art has put forth several designs for illuminated safety signs. Among these are:

U.S. Pat. No. 6,178,677 to Frederick A. Williams describes a vehicle mounted, rear directed message display apparatus including a housing which includes a transparent rear wall, a front wall, side walls, a bottom wall and a cover. Support assemblies are connected to the side walls and extend downward. Illumination lamps are supported inside the housing near the front wall. A display sign is supported inside the housing between the illumination lamps and the transparent rear wall. The display sign includes an opaque background and transparent message lettering. An illumination control switch is electrically connected to the illumination lamps. With the invention installed in a front vehicle, when the driver of the front vehicle thinks that a following vehicle is following too closely, the driver of the front vehicle can operate the illumination control switch to light the illumination lamps to illuminate the display sign to warn the driver of the following vehicle that the following vehicle is following too closely. The front wall includes an illumination monitor aperture so that a driver can observe the status of the message display in the rear view mirror of the vehicle.

U.S. Pat. No. 6,177,866 to Patricia O'Connell describes a tailgating warning system including a housing having a rearward face and a forward face. The forward face has a clear window therein exposing a hollow interior of the housing. The rearward face is comprised of a transparent lens. The housing has an interior lens disposed inwardly of the rearward face. The interior lens has flashing indicia disposed thereon. The housing has lights disposed therein. A photoelectric cell is disposed within the housing and is directed outwardly of the rearward face. The photoelectric cell is in communication with the lights and flashing indicia of the housing. The photoelectric cell is in communication with the accelerator of the vehicle whereby activation of the photoelectric cell is achieved only after a predetermined speed is reached by the vehicle.

US Patent 2004/0183659 to Eddie Somuah describes a digital message display for vehicles that detects a tailgater and automatically flashes a warning message, directed to the tailgater, on a message display that is located in the rear window of the vehicle in view of following traffic. In addition to the warning message directed to the tailgater, a distance display is located in view of the vehicle driver to indicate the distance of the tailgater. An audible alarm alerts the driver to the presence of the tailgater. Additionally, a wireless remote control device allows the driver to manually select and display one of a number of predefined safety and courtesy messages.

None of these prior art references describe the present invention.

### SUMMARY OF THE INVENTION

It is an object of the present invention to provide an illuminated electronic sign that is easily installable on a vehicle and displays a visible request to a following driver to cease unsafe tailgating.

### BRIEF DESCRIPTION OF THE DRAWINGS

FIG. 1 is a functional prototypical view of the present invention installed in a rear window of a vehicle.

FIG. 2 is a functional prototypical view of the present invention installed on a rear bumper of a vehicle.

### DETAILED DESCRIPTION OF THE INVENTION

Every day, thousands of motorists across the country are involved in automobile accidents. Ranging in degree from mild fender benders where the involved parties walk away unscathed to serious pileups where the involved parties end up permanently disabled or lose their lives, an automobile accident can be a traumatic, life altering experience. As many police officers, patrolmen, paramedics and doctors agree, a majority of these accidents are avoidable. Caused by a variety of factors including road conditions, failure to obey traffic signs or signals, and internal distractions such as cellular telephones and blaring radios, many of these accidents are avoidable if the driver was paying close attention to the road ahead. Every day, a great number of accidents occur as a result of tailgating. This accident stems from a vehicle following too closely on the rear of the car ahead of them. Close tailgating causes a driver of the leading vehicle to be distracted from the road. If the driver of the leading vehicle suddenly stops, collision is inevitable. Tailgating can also result in road rage. When people experience road rage, they naturally feel the need to let the offending driver know of their anger. Speeding up or slowing down to shout at the other driver or offering obscene gestures often results in serious and many times fatal accidents.

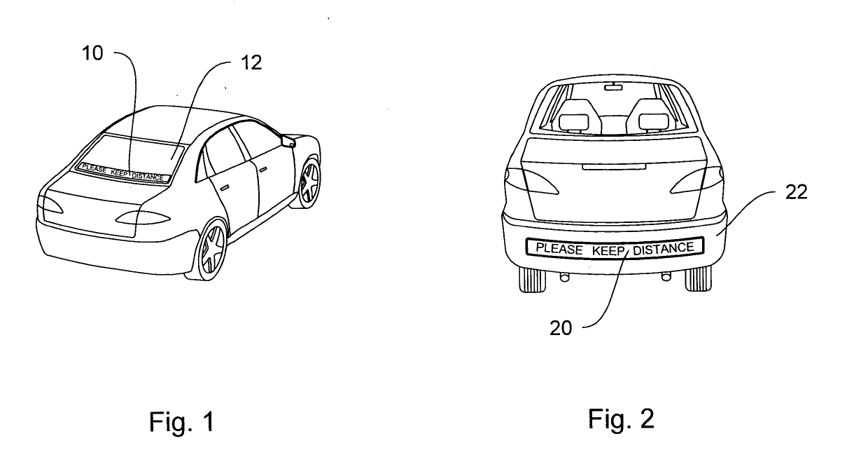

The present invention, hereinafter referred to as Accident Prevention Device, is an illuminated sign kit that is easily installed in a vehicle's rear window, shown in FIG. 1, or on a vehicle's rear bumper, shown in FIG. 2. When activated by an internally contained button, the sign displays a visible request to another driver to cease unsafe tailgating. In an alternate version of the present invention, the sign kit includes an installable sensor mechanism for initiating automatic illumination of a safety message when a following vehicle is within a specific distance of the leading vehicle. In an embodiment, the device includes a motion sensor to cause the sign to brighten when an approaching vehicle is within 10 feet.

Rectangular in shape, the Accident Prevention Device can be any appropriate size, but in an embodiment, the sign measures approximately five inches in height, twenty inches in length, and three eighths to one quarter inch in width. The present invention is manufactured of lightweight yet durable, clear acrylic plastic material and comprised of electronic components. In an embodiment shown in FIG. 1, the Accident Prevention Device 10 is secured inside the car to the rear window 12 by means of an adhesive strip (not shown) or clear rubber suction cups (not shown) placed at each corner of the sign box. In an embodiment shown in FIG. 2, the sign 20 is attached to the rear bumper 22 of a vehicle by peel-off adhesive backing. The bumper version can also include a thick rubber backing to add cushion in the event of contact. The thick rubber backing can be any appropriate thickness, such as one inch, for example.

An illuminated message succinctly displays words such as PLEASE FOLLOW AT A SAFE DISTANCE, PLEASE KEEP DISTANCE, or PLEASE DON'T TAILGATE. Displayed by brilliantly illuminated lights, this message is activated by means of a simple switch which is located within the sign and operated by way of a remote button included within the kit. Once activated, the remote button and switch cause a series of bulbs located within the present invention to illuminate and display the aforementioned message. Boldly emblazoned in bright block letters, the message request immediately flashes across the sign, reading from left to right. The Accident Prevention Device is powered by the battery of the vehicle. An elongated power cord and integrated adapter attaches to the base of the sign and plugs into the car's power outlet. The present invention also is incorporable into new vehicles at point of manufacture.

Application and use of the Accident Prevention Device is very simple and straightforward. First, the user installs and powers the Accident Prevention Device according to easily followed package instructions. After securing the Accident Prevention Device in place, the user connects the sign to a power supply. Placing a remote button in an easily accessed location such as on the passenger seat, dash board or in the glove compartment, the user then drives the car as normal. In the event that another driver exhibits unsafe behavior by tailgating, the user activates the Accident Prevention Device by depressing the button, which then illuminates the safety message brightly across the sign and rear window. After use, the user turns off the Accident Prevention Device sign until again needed. Alternatively, the sign is deactivated when the car is turned off.

The Accident Prevention Device provides drivers with an effective means of reminding other motorists to safely follow safety rules of the road. By viewing this eye catching sign, tailgating motorists are given an opportunity to reduce their speed and discontinue the unsafe activity before front and rear collisions occur. Durably constructed of quality materials, the Accident Prevention Device will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An illuminated sign that is easily installable on a vehicle and capable of displaying a visible request to a following driver to cease tailgating comprising a mountable rectangular sign capable of displaying a visible request to another driver to cease unsafe tailgating, and further comprising a remotely operated switch to activate lighting means to illuminate the sign.

2. The illuminated sign of claim 1 wherein the sign is mounted in a rear window of a vehicle.

3. The illuminated sign of claim 2 wherein the sign is mounted to the rear window of vehicle by means of clear suction cups at each corner of the rectangle of the sign.

4. The illuminated sign of claim 2 wherein the sign is mounted to the rear window of a vehicle by means of an adhesive strip applied to the back of the sign.

5. The illuminated sign of claim 1, wherein the sign is mounted to the rear bumper of a vehicle.

6. The illuminated sign of claim 5, wherein the sign is mounted to the rear bumper of a vehicle by means of an adhesive strip.

7. The illuminated sign of claim 6 further comprising a rubber backing to add cushion in the event of contact.

8. The illuminated sign of claim 7, wherein the rubber backing is approximately one inch.

9. The illuminated sign of claim 1 further comprising a sensor mechanism for initiating automatic illumination of a safety message when a following vehicle is within a specific distance.

10. The illuminated sign of claim 9 wherein the specific distance is approximately ten feet. of the leading vehicle.

11. The illuminated sign of claim 1 where in the rectangular sign measures approximately five inches in height, twenty inches in length, and three eighths to one quarter inch in width.

12. The illuminated sign of claim 11, manufactured of lightweight clear acrylic plastic material and comprised of electronic components.

13. The illuminated sign of claim 1 wherein the message displayed on the sign is selected form the group consisting of: PLEASE FOLLOW AT A SAFE DISTANCE, PLEASE KEEP DISTANCE, and PLEASE DON'T TAILGATE.

14. The illuminated sign of claim 1, wherein the illumination of the sign is powered by the battery of the vehicle, further comprising an elongated power cord and integrated adapter attachable to the base of the sign and plugable into the power outlet of the vehicle.
